(19) United States
(12) Patent Application Publication
(10) Pub. No.: US 2014/0049457 A1
(43) Pub. Date: Feb. 20, 2014

(54) ORGANIC DISPLAY UNIT AND DISPLAY HAVING THE SAME

(71) Applicant: Tai-Jiun Hwang, Shenzhen (CN)

(72) Inventor: Tai-Jiun Hwang, Shenzhen (CN)

(73) Assignee: SHENZHEN CHINA OPTOELECTRONICS TECHNOLOGY CO., LTD., Guandong (CN)

(21) Appl. No.: 13/703,412

(22) PCT Filed: Sep. 26, 2012
(86) PCT No.: PCT/CN2012/081969

§ 371 Date: Dec. 11, 2012

(30) Foreign Application Priority Data
Aug. 14, 2012 (CN) 201210288869.1

(51) Int. Cl. G09G 3/32

(52) U.S. Cl. CPC G09G 3/3208
USPC 345/82

(57) ABSTRACT

The present invention provides an organic display unit and the applied display thereof. Each light emitting diode in the organic display unit corresponds to one light unit. Each driving circuit in the organic display unit controls at least two light emitting diodes to lighten and then controls the light unit correspondent to the light emitting diodes to lighten. The present invention reduces numbers of driving circuits to increase the aperture rate of a light unit to meet the high resolution need of a panel

### BACKGROUND OF THE INVENTION

1. Field of the Invention

The present invention relates to a display technology field, more particularly, to an organic display unit and a display having the organic display unit.

2. Description of the Prior Art

Organic Electroluminesence Display (OELD) is a new generation display device. An OELD generally takes Organic Light Emitting Diode (OLED) as light module.

An OLED includes an organic light substance sandwiched between a transparent anode and a metal reflecting cathode lightens. The organic light substance lightens when voltage is applied across the anode and the cathode. Compared with other flat panel display devices, a compact OLED without needing liquid crystal layer and an additional backlight module as a light source is widely used due to lower power consumption, a wider operating range in temperature, and lower costs in production.

Please refer to FIG. 1. FIG. 1 shows a structure diagram of a conventional OELD.

The OELD comprises data lines D′n, scan lines S′n and power lines P′n, and n is a natural number. Each light unit 11 is coupled with one of the data lines D′n, one of the scan lines S′n and one of the power lines P′n, and is arranged with one OLED 12 and a driving circuit (not shown). The driving circuit comprises a switch transistor 13 and a driving transistor 14. The switch transistor 13 is controlled by the scan line S′n. When the switch transistor 13 turns on in response to a high voltage level applied from the scan line S′n, data signals of the data lines D′n are transmitted to the driving transistor 14, so that the OLED 12 is driven to lighten.

The aperture rate of the light unit 11 decreases to reduce light transmittance to not meet the desire of a high resolution panel because every light unit 11 is arranged with a driving circuit.

Such being the case, it is necessary to solve the existing technology problem in the prior art.

### SUMMARY OF THE INVENTION

The present invention provides an organic display unit to solve the problem in the prior art that the aperture rate of a light unit decreases to reduce light transmittance to not meet the high resolution need of a panel because every light unit is arranged with a driving circuit.

According to the present invention, an organic display unit comprising data lines, scan lines, power lines and a plurality of organic light emitting diodes is provided. Each light emitting diode corresponds to a light unit. The organic display unit further comprises a plurality of driving circuits. Each driving circuit controls at least two light emitting diodes to lighten in different time sequences and then controls the light unit corresponding to the light emitting diode to lighten.

In one aspect of the present invention, the organic display unit further comprises additional scan lines, the light emitting diode comprises a first light emitting diode and a second light emitting diode, the additional scan lines comprise a first additional scan line and a second additional scan line;

each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

In another aspect of the present invention, light units controlled by each driving circuit arrange in a direction parallel to the data lines.

In still another aspect of the present invention, light units controlled by each driving circuit arrange in a direction parallel to the scan lines.

The present invention also provides an organic display unit to solve the problem in the prior art that the aperture rate of a light unit decreases to reduce light transmittance to not meet the high resolution need of a panel because every light unit is arranged with a driving circuit.

According to the present invention, an organic display unit comprises a plurality of organic light emitting diodes, each light emitting diode corresponding to a light unit. The organic display unit further comprises a plurality of driving circuits. Each driving circuit controls at least two light emitting diodes to lighten and then controls the light unit corresponding to the light emitting diode to lighten.

In one aspect of the present invention, each driving circuit controls at least two light emitting diodes to lighten in different time sequences

In another aspect of the present invention, the organic display unit further comprises data lines, scan lines, power lines, and additional scan lines, the light emitting diode comprises a first light emitting diode and a second light emitting diode, the additional scan lines comprise a first additional scan line and a second additional scan line;

each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

In still another aspect of the present invention, light units controlled by each driving circuit arrange in a direction parallel to the data lines.

In yet another aspect of the present invention, light units controlled by each driving circuit arrange in a direction parallel to the scan lines.

The present invention further provides a display to solve the problem in the prior art that the aperture rate of a light unit decreases to reduce light transmittance to not meet the high resolution need of a panel because every light unit is arranged with a driving circuit.

According to the present invention, a display comprises an organic display unit. The organic display unit comprises a plurality of organic light emitting diodes, each light emitting diode corresponding to a light unit. The organic display unit further comprises a plurality of driving circuits. Each driving circuit controls at least two light emitting diodes to lighten and then controls the light unit corresponding to the light emitting diode to lighten.

In one aspect of the present invention, each driving circuit controls at least two light emitting diodes to lighten in different time sequences

In another aspect of the present invention, the organic display unit further comprises data lines, scan lines, power lines, and additional scan lines, the light emitting diode comprises a first light emitting diode and a second light emitting diode, the additional scan lines comprise a first additional scan line and a second additional scan line;

each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

In still another aspect of the present invention, light units controlled by each driving circuit arrange in a direction parallel to the data lines.

In yet another aspect of the present invention, light units controlled by each driving circuit arrange in a direction parallel to the scan lines.

In contrast to the prior art, the present invention can reduce numbers of driving circuits to increase the aperture rate of a light unit to meet the high resolution desire of a panel by using one driving circuit controlling a plurality of light units to lighten in different time sequences.

These and other features, aspects and advantages of the present disclosure will become understood with reference to the following description, appended claims and accompanying figures.

### BRIEF DESCRIPTION OF THE DRAWINGS

FIG. 1 shows a structure diagram of a conventional OELD.

FIG. 2 is a structure diagram of the organic display unit according to a first preferred embodiment of the present invention.

FIG. 3 is a partial enlarged diagram of FIG. 2.

FIG. 4 is a timing diagram of the scan signals of the scan lines Sn, the first additional scan lines S_odd and the second additional scan lines S_even.

FIG. 5 is a structure diagram of the organic display unit according to a second preferred embodiment of the present invention.

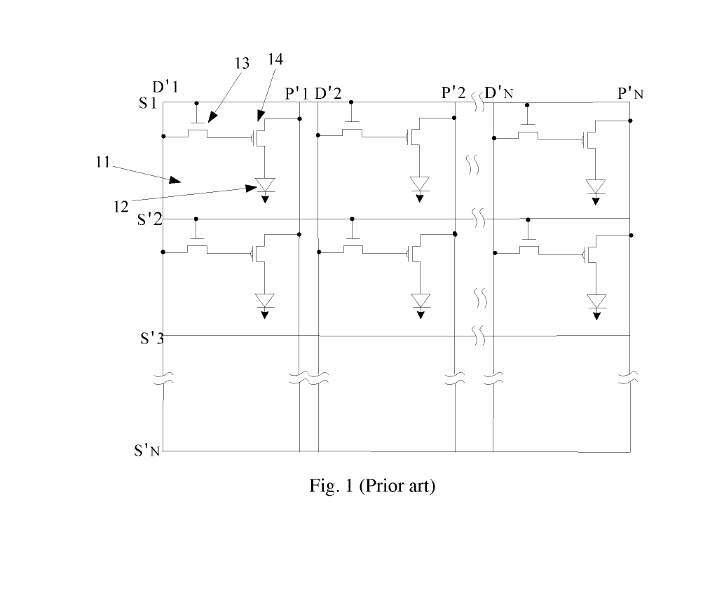

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

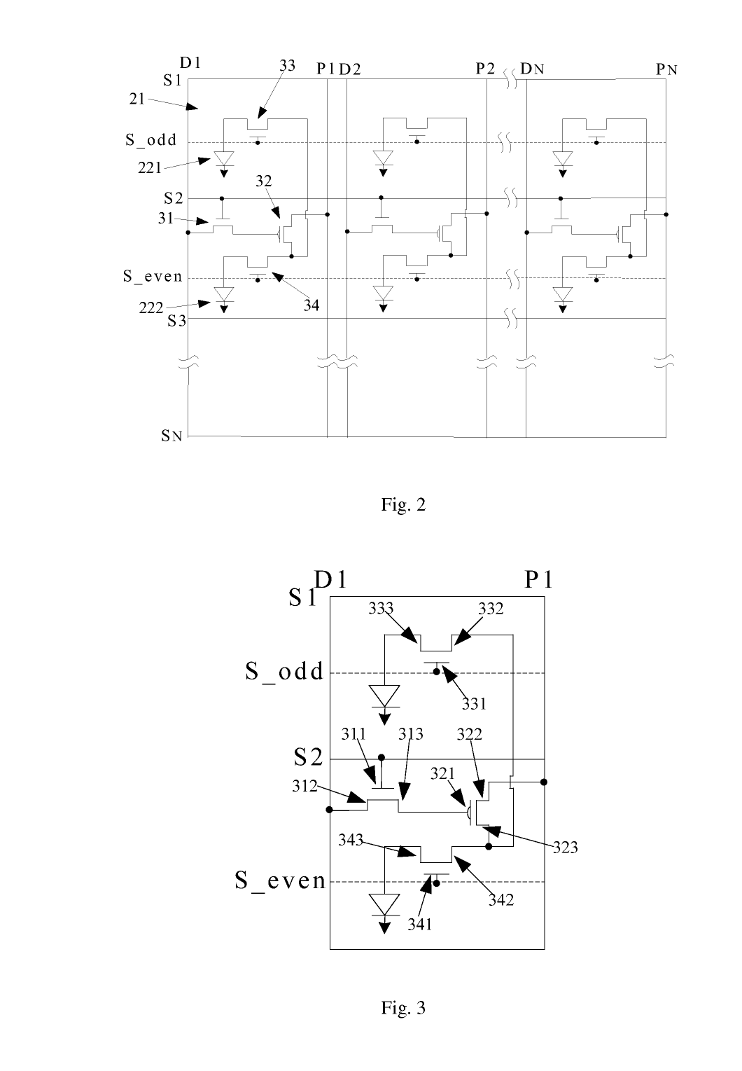

FIG. 2 is a structure diagram of the organic display unit according to a first preferred embodiment of the present invention.

The organic display unit comprises data lines Dn for transmitting data signals, scan lines Sn for transmitting scan signals, and power lines Pn for supplying driving power, and n is a natural number. Each light unit 21 corresponds to one of the data lines Dn, one of the scan lines Sn and one of the power lines Pn, and comprises light emitting diodes, such as a first light emitting diode 221 and a second light emitting diode 222 as shown in FIG. 2. The first light emitting diode 221 and the second light emitting diode 222 arrange in a direction of the data line Dn in parallel.

The organic display unit further comprises a plurality of first additional scan lines S_odd and a plurality of second additional scan lines S_even. Each of the first additional scan lines S_odd is between the scan line S2n+1 and the scan line S2n (that is odd line), and each of the first additional scan lines S_even is between the scan line S2n and the scan line S2n+1 (that is even line). The first additional scan lines S_odd and second additional scan lines S_even are respectively corresponding to the light units in odd lines and the light units in even lines. The first additional scan lines S_odd and the second additional scan lines S_even alternatively transmit scan signals. The detail description is illustrated in the following.

The organic display unit in FIG. 2 further comprises driving circuits (not shown) for driving the first light emitting diode 221 and the second light emitting diode 222. Each of the driving circuits comprises a first transistor 31, a second transistor 32, a third transistor 33, and a fourth transistor 34.

Please referring to FIG. 3, FIG. 3 is a partial enlarged diagram of FIG. 2. A gate 311 of the first transistor 31 connects with the scan line S2, the source 312 connects with the data line D1, and the drain 313 connects with the gate 321 of the second transistor 32. The source 322 of the second transistor 32 connects with the power line P1, and the drain 323 respectively connects with the source 332 of the third transistor 33 and the source 342 of the fourth transistor 34. The gate 331 of the third transistor 33 connects with the first additional scan lines S_odd, and the drain 333 couples ground via the first light emitting diode 221. The gate 341 of the fourth transistor 34 connects with the second additional scan lines S_even, and the drain 343 couples ground via the second light emitting diode 222.

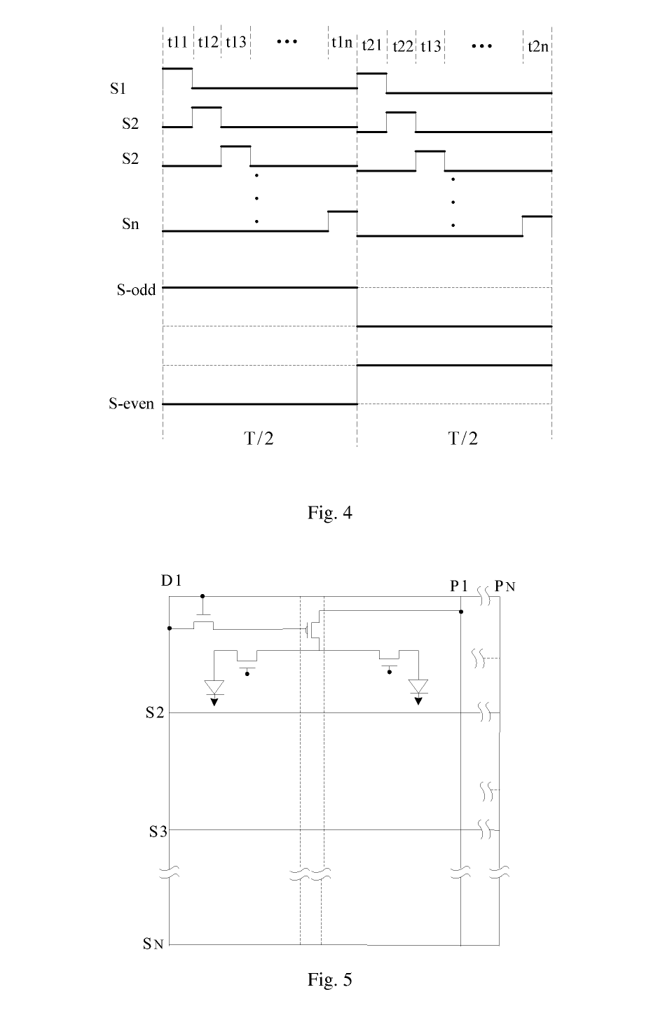

Please refer to FIG. 4. FIG. 4 is a timing diagram of the scan signals of the scan lines Sn, the first additional scan lines S_odd and the second additional scan lines S_even. The following illustrates the operating principle of the first preferred embodiment of the present invention based on FIG. 2, FIG. 3 and FIG. 4.

The first additional scan line S_odd and the second additional scan line S_even alternatively transmit scan signals in one frame period T. The first additional scan line S_odd transmits a high voltage level, the second additional scan line S_even transmits the low voltage level, and the scan line Sn transmits scan signals in order during the first T/2 time period. And during the second T/2 time period, the second additional scan line S_even transmits the high voltage level, the first additional scan line S_odd transmits the low voltage level, and the scan line Sn transmits scan signals in order.

Take the first T/2 time period as an example, the scan line transmits the high voltage level during the t11 time, but all light units do not lighten because the scan line S1 does not connects with any of circuits.

During the t12 time period, the scan line S2 transmits the high voltage level for turning the first transistor 31 on. The second transistor 32 turns on because data signals of the data line D1 are transmitted to the second transistor 32 so that the current from the power line P1 flows through the second transistor 32. In the meantime, the third transistor 33 turns on when the first additional scan line S_odd transmits the high voltage level. Therefore, the first organic light emitting diode 221 lightens because the current from the second transistor 32 flows to the third transistor 33 through the drain 323 and then to the first organic light emitting diode 221 through the drain 333 of the third transistor 33. For the same reason, all light units in the first line lighten.

The driving ways in the t13, t14 and the subsequent t1 (2n−1), t1 (2n) time periods are similar with those in the t11 and t12 time periods. The light units in the odd lines lighten in order because the first scan line S_odd transmits the high voltage level during the first T/2 time period.

During the second T/2 time period, all light units in the t21 time do not lighten when the scan line S1 transmit the high voltage level because the scan line S1 does not connect to any of the circuits.

During the t22 time period, the scan line S2 transmits the high voltage level for turning the first transistor 31 on. The second transistor 32 turns on because data signals of the data line D1 are transmitted to the second transistor 32 so that the current from the power line P1 flows through the second transistor 32. In the meantime, the fourth transistor 34 turns on when the first additional scan line S_even transmits the high voltage level. Therefore, the second organic light emitting diode 222 lightens because the current from the second transistor 32 flows to the fourth transistor 34 through the drain 323 and then to the second organic light emitting diode 222 through the drain 333 of the fourth transistor 34. For the same reason, all light units in the second lines lighten.

The driving ways in the t23, t24 and the subsequent t2 (2n−1), t2 (2n) time periods are similar with those in the t21 and t22 time periods. The light units in the even lines lighten in order because the second scan line S_even transmits the high voltage level during the second T/2 time period.

The present invention provides one driving circuit shared by two light units to control the two light units to lighten in the different time sequence. In this way, the light units in odd lines and the light units in even lines lighten in the order of the time sequence and in alternative. Obviously, the present invention is capable of reducing numbers of driving circuits to increase the aperture rate of a light unit to meet the high resolution need of a panel.

In addition to using one driving circuit to drive two light units as illustrated in the first embodiment, practically, using one driving circuit to drive three or more light units to lighten in different time sequences also belongs to the scope of the present invention. Furthermore, a driving circuit needs as many additional scan lines as the driven light units. For instance, it needs three additional scan lines when a driving circuit drives three light units. There is no more description because the principle is the same.

In addition, it is allowed that the light units, driven by each driving circuit, in different arrangement orders. For example, the two light units driven by the same driving circuit of the first preferred embodiment in FIG. 2 are arranged along a direction parallel to the data lines Dn. In another embodiment, the two light units driven by the same driving circuit are arranged in along parallel to the scan lines Sn. For instance, referring to FIG. 5, the arrangement order for three or more light units is similar when the light units, driven by a driving circuit, in odd rows and in even rows lighten alternatively. Therefore, there is no need for further description.

The present invention further provides a display, e.g. a liquid crystal television or a personal handset terminal The display comprises the present inventive organic display unit. There is no more description for the device because the detail has been mentioned above.

The present invention reduces numbers of driving circuits to increase the aperture rate of a light unit to meet the high resolution need of a panel by a plurality of light units share one driving circuit which controls the plurality of light units to lighten in different time sequences.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. An organic display unit comprising data lines, scan lines, power lines and a plurality of organic light emitting diodes, each light emitting diode corresponding to a light unit, and the organic display unit further comprising a plurality of driving circuits, wherein each driving circuit controls at least two light emitting diodes to lighten in different time sequences and then controls the light unit corresponding to the light emitting diode to lighten.

2. The organic display unit of claim 1, wherein the organic display unit further comprises additional scan lines, the light emitting diode comprises a first light emitting diode and a second light emitting diode, the additional scan lines comprise a first additional scan line and a second additional scan line;
each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

3. The organic display unit of claim 2, wherein light units controlled by each driving circuit arrange in a direction parallel to the data lines.

4. The organic display unit of claim 2, wherein light units controlled by each driving circuit arrange in a direction parallel to the scan lines.

5. An organic display unit comprising a plurality of organic light emitting diodes, each light emitting diode corresponding to a light unit, and the organic display unit further comprising a plurality of driving circuits, wherein each driving circuit controls at least two light emitting diodes to lighten and then controls the light unit corresponding to the light emitting diode to lighten.

6. The organic display unit of claim 5, wherein each driving circuit controls at least two light emitting diodes to lighten in different time sequences

7. The organic display unit of claim 5, wherein the organic display unit further comprises data lines, scan lines, power lines, and additional scan lines, the light emitting diode comprises a first light emitting diode and a second light emitting diode, the additional scan lines comprise a first additional scan line and a second additional scan line;
each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

8. The organic display unit of claim 7, wherein light units controlled by each driving circuit arrange in a direction parallel to the data lines.

9. The organic display unit of claim 7, wherein light units controlled by each driving circuit arrange in a direction parallel to the scan lines.

10. A display comprising an organic display unit, the organic display unit comprising a plurality of organic light emitting diodes, each light emitting diode corresponding to a light unit, and the organic display unit further comprising a plurality of driving circuits, wherein each driving circuit controls at least two light emitting diodes to lighten and then controls the light unit corresponding to the light emitting diode to lighten.

11. The display of claim 10, wherein each driving circuit controls at least two light emitting diodes to lighten in different time sequences

12. The display of claim 10, wherein the organic display unit further comprises data lines, scan lines, power lines, and additional scan lines, the light emitting diode comprises a first light emitting diode and a second light emitting diode, the additional scan lines comprise a first additional scan line and a second additional scan line;
each driving circuit comprises a first transistor, a second transistor, a third transistor and a fourth transistor, wherein a gate and a source of the first transistor respectively connect with one of the scan lines and one of the data line, a drain of the first transistor connects with a gate of the second transistor, a source of the second transistor connects with one of the power lines, a drain of the second transistor respectively connects with a source of the third transistor and a source of the fourth transistor, a drain of the third transistor couples ground via the first light emitting diode, a gate of the third transistor connects with the first additional scan line, a drain of the fourth transistor couples ground via the second light emitting diode, and the first additional scan line and the second additional scan line alternatively transmit scan signals.

13. The display of claim 12, wherein light units controlled by each driving circuit arrange in a direction parallel to the data lines.

14. The display of claim 12, wherein light units controlled by each driving circuit arrange in a direction parallel to the scan lines.
